(19) United States
(12) Patent Application Publication
(10) Pub. No.: US 2002/0183418 A1
(43) Pub. Date: Dec. 5, 2002

(54) Design and synthesis of instant-degradable plastics

(76) Inventor: Oren Rosen, Jerusalem (IL)

Correspondence Address: Rashida A. Karmali, Suite 2525, 230 Park Avenue, New York, NY, 10169, US

(21) Appl. No.: 09/776,284

(22) Filed: Feb. 2, 2001

(51) Int. Cl. C08K 3/00

(52) U.S. Cl. 523/124

(57) ABSTRACT

A novel class of instantly degradable synthetic polymeric plastics having the characteristics and properties of conventional forms of plastics is developed by providing the disulfide and sulfenyl derivatives of the plastic compounds with latent nucleophilic properties. These novel plastic products are made from a variety of compositions of polymers and their compatible nontoxic modifiers. The resulting novel instant degradable plastic products retain latent solubility properties that are triggered upon mild chemical reaction, thus enabling cost effective and facile recycling of plastic refuge.

### FIELD OF INVENTION

This invention relates to a novel class of instantly degradable synthetic polymers having the characteristics and properties of conventional plastics and methods of synthesis, which require minimal modification of current industrial machinery and production infrastructure. Specifically, the present invention provides a cost effective and easy way to prepare monomers and polymers which are degradable compositions of plastics and other polymers containing latent amino-sulfenyl, the oxygen-sulfenyl or the disulphide moieties, which enable the plastics to be defined as “instant-degradable plastics”, and to develop processes suitable for the production of these products.

### BACKGROUND OF THE INVENTION

It would be difficult to imagine a world without plastics. Among the most versatile materials ever developed, plastics can be made to resemble and even replace such diverse materials as metal, wood, glass, china, stone cloth, rubber, jewels, glue, cardboard, varnish or leather. As many as fifty or more types of plastics exist, with new ones being developed as research continues. Different plastics are used for different purposes, but most of them tend to be strong, durable, lightweight, and resistant to corrosion. They are often less expensive than other materials and can be made in a variety of colors.

Plastics and other polymers are in theory recyclable, but after a relatively short functional life, are destined to arrive as a significant component of trash. Most of these plastics and other polymers disposed of in landfills are chemically stable and degrade minimally. The problem also arises of what to do with millions of tons of plastic waste. In response, the plastic industry and environmental groups are studying ways to recycle plastics. Some plastic objects can be ground up and reprocessed into new products. For example, soft drink bottles made of polyethylene terephthalate (PET) and high-density polyethylene milk jugs have been refabricated into such products as filler for down jackets and sleeping bags, insulation, strapping materials and plastic lumber. The effects of plastics on the environment go beyond the issue of recycling. Plastic foam processors, for example, have used chlorofluorocarbons (CFC) as foaming agents. There is now evidence that CFCs deplete the atmospheric ozone layer that protects the earth by blocking out much of the sun's ultraviolet radiation.

This is an increasing problem of plastic pollution in the environment, while the demand for plastics keeps on increasing in most consumer products. Furthermore, the availability of landfill space is diminishing, while there is a worldwide trend toward more stringent regulatory requirements on landfills. Some research and commercial efforts have been directed toward the development of new uses for polymerized products such as scrap, waste tires or rubber. However, because of the high costs associated with the use of plastics this approach has not gained wide acceptance. It is therefore necessary to develop alternative pathways for production of a new class of plastics and a considerable amount of attention has been devoted towards recycling and reclaiming plastics and other polymers.

There are two broad groups of polymers and copolymers classified according to their polymerization: a) condensation polymers, for example polyesters, nylon or polycarbonates, and polyurethane having a polymerized form with a lower molecular weight than the sum of monomers used to make them, and b) chain growth or addition polymers, such as polyethylene, polystyrene and polypropylene that have the same molecular weight as the sum of the monomers used to make them, and are made in specific conditions of temperature and pressure and in the presence of a catalyst.

Polymers are generally broken down by two ways: pyrolysis and depolymerization. Pyrolysis requires high temperature conditions known as thermal cracking, a process in which polymer molecules are heated until they fragment into several smaller and randomized-sized molecules, for example, a mixture of alcohols or hydrocarbons, none of which is an original monomer.

Depolymerization is carried out at significantly milder thermal conditions than those employed in pyrolysis and prior art teaches several hydrolytic methods, for example, glycolysis, methanolysis or hydrolysis, based on the depolarization reagent used, such as glycol, methanol, or water respectively, wherein under specific conditions of temperature and pressure, with or without a catalyst, the polymer chain separates into its original monomers.

A number of compounds with carbon-carbon double bonds are used in the preparation of polymers. Alkenes of the type CH₂═CH−X are used to form polymers of the type

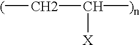

shown below in Table A.

A. Alkenes of the type CH₂═CH—X used to form polymers of the type

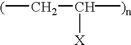

| Compound | Structure | —X in polymer | Application |
|---|---|---|---|
| Ethylene | CH₂═CH₂ | —H | Polyethylene films as packaging material; |
| | | | “plastic” squeeze bottles are molded from |
| | | | high-density polyethylene. |
| Propene | CH₂═CH—CH₃ | —CH₃ | Polypropylene fibers for use in carpets |
| | | | and automobile tires; consumer items |
| | | | (luggage, appliances, etc.); packaging |
| | | | material. |
| Styrene | 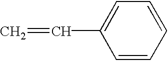 | 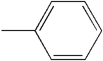 | Polystyrene packaging, housewares, lug- gage, radio and television cabinets. |
| Vinyl chloride | CH₂═CH—Cl | —Cl | Poly(vinyl chloride) (PVC) has replaced |
| | | | leather in many of its applications; PVC |
| | | | tubes and pipes are often used in place |
| | | | of copper. |
| Acrylonitrile | CH₂═CH—C≡N | —C≡N | Wool substitute in sweaters, blankets, etc. |

Alkenes of the type CH2═C×2 are used to form polymers of the type (—CH₂—CX₂₋)ₙ shown below in Table B.

B. Alkenes of the type
CH₂═CX₂ used to form polymers of the type (—CH₂—CX₂—)ₙ

| | | X in | |
|---|---|---|---|
| Compound | Structure | polymer | Application |
| 1,1 -Dichloroethene | CH₂═CCl₂ | Cl | Saran used as air- and |
| (vinylidene chloride) | | | water-tight |
| | | | pack-aging film. |
| 2-Methylpropene | CH₂═C(CH₃)₂ | CH₃ | Polyisobutene is |
| | | | component of “butyl |
| | | | rubber,” one of |
| | | | earliest synthetic |
| | | | rubber substitutes. |

Other chemical structures may also be used to form polymers as shown below in Table C.

C. Others

| Compound | Structure | Polymer | Application |
|---|---|---|---|
| Tetrafluoroethene | CF₂═CF₂ | (—CF₂—CF₂—)ₙ(Teflon) | Nonstick coating for cooking utensils; |
| | | | bearings, gaskets, and fittings. |
| Methyl methacrylate | 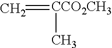 | 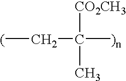 | When cast in sheets, is transparent; used as glass substitute (Lucite, Plexiglas). |
| 2-Methyl-1,3-butadiene | 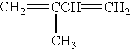 | 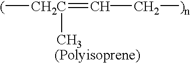 | Synthetic rubber. |

Source: R. C. Atkins and F. A. Carey, Organic Chemistry: A Brief Course, McGraw-Hill, New York, 1990, p. 132.

Generally fifty percent or over, of the manufactured polymers are used as packaging materials and about ninety percent of this flow finishes as a component of ecological garbage. Much effort has been put into developing synthetic polymers intended for packaging, which are capable of being broken down chemically and physically by environmental actions or by biological processes. Such polymers are described as biodegradable.

Biodegradability can be defined as the degradation at the molecular level of substances by the action of enzymes derived from the metabolic processes of microorganisms. The synthetic polymers may also be collected in a reservoir containing bioactive bacteria and microbes, which degrade the plastics to environmentally non-toxic degradation products. However, problems exist in the recycling and purification of monomer degradation products because these products may not be reincorporated into plastics in a cost-effective process. Moreover, the degradation process is time consuming and bio-hazardous, and often results in accumulation of heaps of biohazardous garbage.

Some polymers are known to degrade by hydrolysis in the presence of water and thereby decompose to smaller chemical units. Some of these polymers are also biodegradable, such as polylactic acid and polyglycolic. Due to the expense and difficultly in preparing these hydrolytically degradable polymers, their use has been largely confined to high cost medical applications where bioabsorbable materials are required.

The object of the present invention is to provide cost effective and easy to prepare degradable compositions of monomers, polymers and plastics of all types containing the amino-sulfenyl (═—NH—S—), the oxygen sulfenyl (═—O—S—), the disulfide (═—S—S—) moieties, and ways to develop processes for their production and to enable these compositions to be used as instantly degradable plastics.

### SUMMARY OF INVENTION

The present invention is directed towards a variety of degradable plastic products, which, are made of instantly degradable materials. Specifically the degradable materials are non-toxic hydrolytically degradable polymers produced by reacting a monomer with a non-toxic modifier with amino sulfenyl, oxygen sulfenyl or inert disulphide bond. The modifier is compatible with existing polymer and is nonvolatile and nontoxic. The various materials of the present invention include films, molded products, laminates, foams, powders, nonwovens, adhesives, and coatings. The degradable polymers of the present materials are typically hydrolytically degradable, and/or are degradable under reducing conditions, because of the presence of latent amino sulfenyl, oxygen sulfenyl disulphide functional groups of the polymer. The modifier is nonvolatile and typically has a vapor pressure of less than about 158-163° C./3.5 mm Hg Torr at 180° and a boiling temperature above about 280° at 1 atmosphere. Importantly, the instant degradation can be applied to thermoplastic as well as thermoset polymers including, but not limited to, polyurethanes, unsaturated polyesters or epoxy resins. By incorporating the latent amino sulfenyl, oxygen sulfenyl disulphide bonds into thermoplastic and thermoset resins, it is possible to solubilize them, under defined conditions, preferably under aqueous conditions these highly insoluble polymeric resins for further recycling and disposal processes.

The degradable materials of the present invention are useful for the production of commercial and consumer products. Such products include, but are not limited to, products for controlled release of chemicals, oral drug delivery products, automobile products, gardening products, consumer products, health products, substrates that are suitable for the attachment and growth of living cells, construction products, adhesive products, absorbent articles, flammable products, lubricants, bags, netting, rope, coatings, filters, containers, packaging, clothing, and paper goods. The degradable materials of the present invention are particularly useful for the production of frequently littered products such as, drink containers, labels, food packaging, printed matter, construction material and vehicle supplies.

The present invention is also directed towards processes for making the various degradable materials of the present invention. The process includes forming a composition, which includes a nontoxic hydrolytically degradable polymer and a nontoxic modifier, wherein the modifier is compatible with the polymer, into various materials of the present invention under conditions such that the modifier is substantially nonvolatile and nonfugitive.

The principal objectives of this invention are 1) to provide substituted disulfide amino sulfenyl, oxygen sulfenyl plastic products which have comparable utility to currently produced various types of plastics, and have the advantage over the latter because of the ease with which they can be degraded using appropriate machinery and plant structures, and 2) to provide an environmentally acceptable and economically feasible process, whereby the monomeric units and/or their other useful degradation product units, from which plastics are made can be recovered for environmentally beneficial and commercially profitable applications and reuse.

A further objective is to apply depolymerization technology to cause the polymer molecules to break down into molecules from which they were made, i.e., monomeric units and non-toxic modifiers with an inert disulphide amino sulfenyl, oxygen sulfenyl bond.

An additional objective is to simplify and improve the process and the final plastic product recovery, by adding a step for removing interfering complex chemical additives from the plastic products, and by optimizing the reaction conditions for the fracturing of the chemical bonds within the polymer.

An additional objective of this invention is to provide a useful and cost effective solution for new machinery necessary, in the application of the processes of the present invention, by employing comparable and compatible hardware and procedures to those used in current industry practice. The main technological difference between the existing processes and the newly proposed processes of the present invention, is in the introduction of new chemical monomer formulations which sustain the defined instant-degradability properties defined in this invention, while retaining the useful mechanical properties of plastics for commercial applications. This may facilitate the introduction of the invention industry-wide at economically attractive terms, while remaining environmentally friendly.

An additional objective of this invention is to overcome problems of scaling, and to satisfy production capacity requirements by employing up to two or more moderately sized polymerization reactors operating simultaneously under similar process conditions.

Another objective of this invention is to provide a process whereby the reclamation of waste polymers does not contribute pollutants to the atmosphere as do some other procedures currently used in burning tires to produce energy.

It is also an objective to produce especially designed monomers and combinations thereof, to provide instant-degradable plastics with desirable properties such as resistance to heat, toughness and flexibility.

Another objective of this invention is to provide a process, which will provide reusable monomers at a cost lower than the cost of manufacturing fresh plastic monomers from crude oil and natural gas.

These and other objectives of this invention are accomplished, in broad aspect, by the synthesis of disulphide amino sulfenyl, oxygen sulfenyl derivatives of plastic products in general, and by the simple, mild degradation of these plastic products in environmentally friendly conditions.

### DETAILED DESCRIPTION OF THE INVENTION

Additional objects, features and advantages of the present invention will become apparent by referring to the following description of the invention in connection with the accompanying drawings.

The invention is directed to a variety of degradable plastic products, which contain the disulphide form, and are instantly degradable. The basic processes for the degradation of the plastic products are for the most part identical. In some instances such as in polystyrene, a different chemical system is used to acieve the catalytic instant-degradation quality described in the present invention, in order to accomplish the general objectives of the present invention. Thus, although waste plastics can be degraded according to the present invention, for simplicity reference is only made to the processing of used plastics, including, but not limited to, nylons, polyurethanes, polyesters, polyamides, or polystyrenes. The technology applies to all of the different fifty or so types of plastics that are currently available.

The modifier is compatible with the polymer and is nonvolatile and nonfugitive. The various materials of the present instant degradable polymers of the invention include films, molded products, laminates, foams, powders, nonwovens, adhesives and coatings. The instant degradable materials of the present invention are useful for the production of commercial and consumer products. Such products include, but are not limited to, products for controlled release of chemicals, oral drug delivery products, automobile products, gardening products, consumer products, health products, substrates that are suitable for the attachment and growth of living cells, construction products, adhesive products, absorbent articles, flammable products, lubricants, bags, netting, rope, filters, inks, containers, packaging, drink containers, labels, food packaging, pharmaceutics and construction supplies.

The present invention is also directed towards processes for making the various degradable materials of the present invention. The processes include forming a predetermined, predesigned composition which includes a nontoxic, hydrolytically degradable polymer with the desired mechanical and commercial specifications, and a nontoxic modifier, wherein the modifier is compatible with the polymer, into the various materials of the present invention under conditions such that the modifier is substantially nonvolatile and nonfugitive. As used herein, “degradable” with reference to the various materials of the present invention refers to a material including a degradable polymer as described below. The term “degradable” with reference to the polymer, refers to a polymer having a polymer molecular structure which can decompose to smaller molecules. As discussed below, the degradable polymer can be hydrolytically degradable in which water reacts with the polymer to form two or more molecules from the polymer. The degradable polymer can be degraded by a reduction process. For example, non-toxic reducing thiols can be used to cleave latent disulphide bonds in the above mentioned family of instant-degradable polymers, in order to induce the catalytic disassembly and dissolution of plastic product into aqueous solution.

The degradable polymers of the present invention further can be made degradable within a time frame in which products made from the materials, after use, can either be readily recycled by decomposition of the polymer into monomeric units or, if disposed of in the environment, such as in landfills, the polymer degrades quickly enough to avoid significant accumulation, and is significantly less than that of similar products which are not degradable. The materials of this invention degrade instantly or in a time period of a few months, whereas similar mass-produced, nondegradable products require typically, decades to centuries.

Reducing agents used in the present invention for the degradation of target polymers include, but are not limited to, 2-mercaptobenzimidazole, 2-mercapto-5-benzimidazole sulfonic acid sodium salt dihydrate; 2-mercaptobenzoic acid or thiosalicylic acid; 3-mercaptobenzoic acid; 4-mercaptobenzoic acid; 2-mercaptobenzothiazole; 2-mercaptobenzooxazole; 2-mercaptoethanesulfonic acid sodium salt; 2-mercaptoethyl trimethyl ammonium bromide acetate; 2-mercaptoethyl trimethyl ammonium iodide acetate; 2-mercaptoimidazole; 8-mercaptomenthone; 2-mercapto-5-methylbenzimidazole; 2-mercapto-1-methylimidazole; 5-mercapto-l-methyltetrazole; 2-mercapto-5-methyl, 1,3,4-thiadiazole; 3-mercapto-4-methyl-4-H-1,2,4 triazole; 3 mercaptopropanediol; 3-mercapto-1-propane sulfonic acid sodium salt; 3-mercaptopropionic acid; n-2-mercaptopropionyl glycite; meraptosuccinic acid; 2-mercaptoacetic acid; cysteine, glutathione and other cysteine containing peptides, sodium borohydride; or sodium cyano borohydride; mercaptopyruvic acid sodium salt.

Reducing agents having the thiol group or mercapto compounds in general, can be incorporated into polyionic, non-toxic bimolecules in order to retain the specified reducing conditions for instant-degradable polymers on the one hand, while enabling non-toxic disposal and handling of the polymeric degradation products, for example

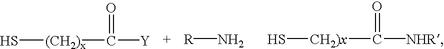

Where x=1, n; Y=activating group, R=peptide, sugar, other molecules.

The thiolic reducing agents include, but are not limited to, 6-mercaptoguanosine; 8-mercaptoguanosine; 2(R)-2-mercaptomethyl-4-methylpentanoyl-β-(-2naphthyl)-ala-ala-amide; (2R)-2-mercaptomethyl-4-methylpentanoyl-phe-ala-amide; N-(2-mercaptopropionyl)-glycine; 2-mercaptopurine; 6-mercaptopurine; 6-mercaptopurine-2′-deoxy-riboside; 6 mercaptopurine riboside; B-mercaptovaline. Generally, the mercapto compounds can be incorporated into polyionic (non-toxic) biomolecules to retain reducing conditions and to enable non-toxic disposal and handling of the polymerics products.

The degradation characteristics of the polymer in the present materials depend in large part on the type of material being made with the polymer. Thus, the polymer needs to have suitable degradation characteristics so that when produced into a final material, the material does not undergo significant degradation until after the useful life of the material. Therefore, different embodiments of the present invention will have different degradation characteristics.

Monomer precursors for incorporating latent disulphide nuclei in the instant degradable polymers of the present invention include:

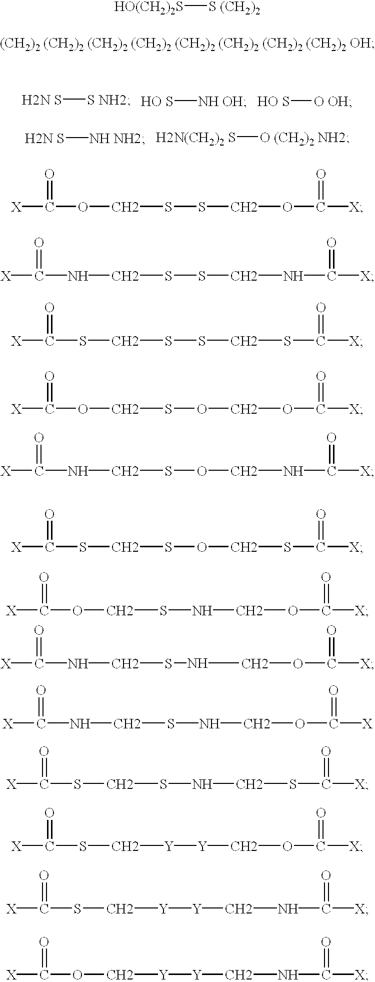

where Y—Y═—S—NH; —O—S—; or 2,2′-Dithiosalicylic acid and its derivatives. These types of sulfur-oxygen, sulfur-nitrogen bonds undergo thiolytic degradation and are incorporated as latent nuclei in the instant degradable polymeric plastics. The general feature is represented as

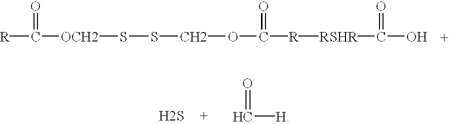

This type of degradation in the family of S—NH, S—O, and S—S groups occur to facilitate the instant degradation of the plastics with corresponding families of plastics. The general scheme is:

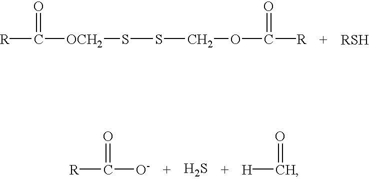

which applies to instant degradable plastics within this family of S—NH, S—O, S—S groups which facilitate instant degradation of such plastic disulfides and sulfenyls.

Additionally, the synthesis of special monomers as building units for radical co-polymerization of instant degradable polystyrene is carried out using allyl mercaptan and bezenethiol or allyl mercaptan and chloramine.

The polymer of the present invention can also be used to produce articles which, because the articles require durability in the use for which the article is designed, are not degradable under ambient conditions within the time frame of the useful life of the article. As such, in another aspect of the present invention, the polymer can be used to produce such durable articles. Such articles are, nonetheless, considered to be degradable and are particularly useful because they can be treated to accelerate degradation and therefore, are degradable upon demand. For example, the polymer can be exposed to environmental conditions which accelerate degradation, as for example, yeast releasing thiolic compounds such as glutathione, or the polymer may be collected into resevoirs with specially prepared aqueous solutions containing reducing agents.

The polymer of the present invention can be characterized as being reductively degradable. As used herein, the term “reductively degradable” refers to a composition in which the disulphide bonds in the molecule are subject to reduction, thus producing smaller molecules.

The polymer of the present invention can be characterized as being hydrolytically degradable. As used herein, the term “hydrolytically degradable” refers to a composition in which chemical bonds in the molecule are subject to hydrolysis, thus producing smaller molecules. In another embodiment of the present invention, the polymer is biodegradable. The catalytic hydrolysis of the polymers may also be enhanced by controlling the reduction stage of degradation.

The polymer of the present composition may have an average molecular weight of between about 5,000 and about 1,500,000. Appropriate molecular weights will vary according to desired material type as discussed below. The polymer of the present composition can be a homopolymer, a copolymer, or a physical blend of homopolymers and/or polymers. Typically, the polymer of the present materials includes repeating monomer or comonomer units which are selected from the following group and which polymers are non-toxic and degradable:

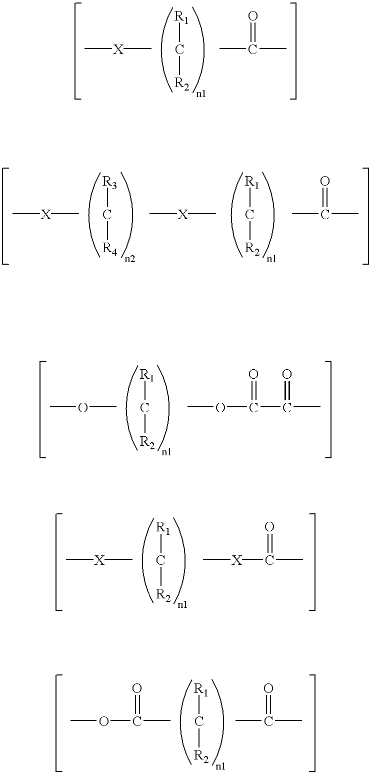

Wherein X is the same or different and is O or NR′ with R′ independently being H, hydrocarbyl, or substituted hydrocarbyl; R1, R2, R3 and R4 can be the same or different and are hydrogen, hydrocarbyl containing 1 to 24 carbon atoms, or substituted hydrocarbyl containing 1 to 24 carbon atoms, and where n1 and n2 can be the same or different and are an integer of from 1-12.

For ethylene, the polymer comprises repeating monomer or comonomer units derived from CH2═CH2 which have been reacted with the disulphide amino sulfenyl or oxygen sulfenyl moiety. Similarly, as shown above in Tables A to C above, the polymer for propene, styrene, vinyl chloride acrylonitrile, and other, comprise of their sulphide derivatives. Properties of a plastic material are greatly influenced by the shape and chemical make-up of the polymer molecule, for example, resistance to heat, toughness and flexibility are among the properties that may be affected by changes in a plastic's polymer molecule. The term “resin” is often used as a synonym for plastic, resin being the raw, unfinished materials. Plastic is the finished product. Resins are found in various forms, including syrup, powder, flakes, or pellets. Resins may be used by themselves or in combination with additives, including fillers, reinforcing agents, plasticizers, stabilizers, colorants, flame retardants, smoke suppressants or processing aids. The disulfide derivatives of the above products described in the present invention maintain all of the properties of conventional products and in addition, make them instantly degradable to facilitate the recycling and processing of used plastics.

Most plastics are described as being thermosetting or thermoplastic. These terms refer to the reaction of a plastic to heat. Thermosetting plastics soften with heat but stay soft only for a short time. They set, or harden, if the heat continues. The process of making thermosetting plastics hard is called curing, which can also be accomplished by chemical means. In curing, the molecules of the plastic link together between chains or cross links. Once these cross links are formed the plastic is no longer soft nor can it be resoftened through heating.

Thermoplastic materials also soften with heat but remain soft if the heat continues. They set only when cool and can be softened many times by reheating. In thermoplstics, the molecular chains do not cross link during the manufacture. Thermoplstics are used for articles that are not subjected to unusual temperature changes, and include acrylonitrile-butadiene-styrene, acetals, acrylics, cellulosics, fluoropolymers, nylons, polycarbonate, thermoplastic polyester, polyethylene, polyethylene terephthalate, polypropylene, polystyrene, and polyvinyl chloride. The disulfide and sulfenyl derivatives of the above products of the present invention, while retaining the essential properties of these products, also provide the useful property of instant degradation under mild conditions.

The instant-degradable products of the present invention are produced using a variety of molding manufacturing methods including extrusion molding, injection molding, blow molding, compression molding, transfer molding, thermoforming, casting, calendering, low-pressure molding, high-pressure laminating, reaction injection molding, foam molding, or coating.

In the following examples, the synthesis and processes for degradation of a few embodiments of the invention are described in detail.

### EXAMPLES

### Example 1

Synthesis of polyurethane

2 Hydroxyethyldisulphide was mixed with the di-isocyanate monomer:Isophorone Diilsocyanate in a volume ratio of 1:1 and in the presence of 1% dibutyltin -dilaureate as catalyst for polymerization of polyurethane. The reaction was allowed to proceed for 3 min. as an exothermic reaction to yield a polyurethane foam. The resulting polyurethane foam was completely insoluble in boiling water for 10 min. It dissolved under appropriate controlled reaction conditions with special polymer -degradation -solubility inducing thiol reducing agents. 0.4 gm of sodium mercaptoethylsulphonate in 10 ml distilled water at pH 7.0 was used.

### Example 2

A mixture of 2-Hydroxyethyl disulfide and dihydroxyethylethylamine at a ratio of 1:1was mixed with isophorone diisocyanate in a volume ratio of 1:1in the presence of 1% dibutyltin dilaureate, a catalyst for polymerization of polyurethane and other plastics under previously defined conditions.

### Example 3

Synthesis of Monomers as Building Units in Radical Co-polymerization of Instant -degradable Polystyrene

The following copolystyrene polymers have intrisic latent instant-degradable chemical properties:

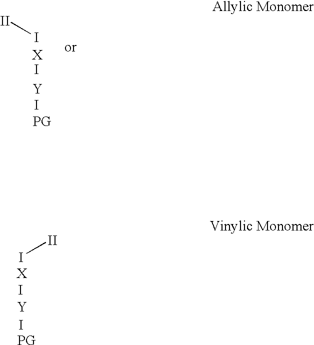

Wherein, PG—Y is a specially designed protective group, X is the latent nucleophile with catalytic properties enabling the polymer backbone degradation instantly upon chemical demand. Additionally, PG must be preferably aromatic, but can be aliphatic; PG must contribute the appropriate aromatic or aliphatic mechanical properties to the general properties of the polystyrene; Y should contain specific covalent bond qualities in order to allow selective cleavage of the protective group upon command; Y should also be a stable chemical bond during product formulation, handling and use; R′—X—Y—R should be stable to radical degradation during styrene co-polymerization; and monomers and degradation products are environmental-friendly and degradation products are of economic value.

Co-polymerization of monomers to obtain a latent nucleophilic nucleus in the polymer backbone is carried out as follows: styrene, newly designed monomers and a third monomer known to co-polymerize and yield ester bonds in polystyrene are mixed, using appropriate co-polymerizing conditions to obtain a co-polystyrene-ester with appropriate mechanical properties . The resulting polymer contains mechanical properties similar to regular polystyrene due to aromatic contribution of the styrene, the aromatic protecting group, and the aromatic group in the third monomer which introduces an ester group in the polystyrene background. The newly designed monomer contains latent solubility properties which upon chemical reaction express the solubility properties, thus enabling facile handling of polymeric rubbish. The newly designed monomer incorporates a latent catalytic nucleophile which upon specific chemical activation starts catalytic intramolecular hydrolysis of the inserted ester bonds in the general co-polystyrene backbone. The monomers are chosen according to commercial and economic requirements regarding purification of degradation products, which may be reused, for example, as peptidomimetic reagents or other fine chemicals.

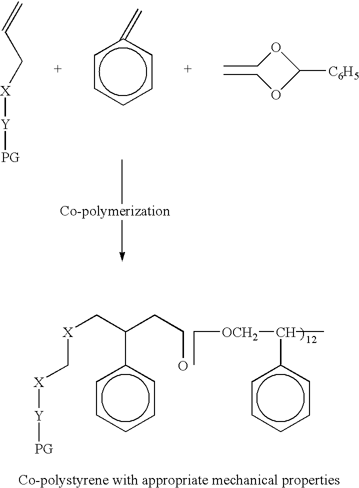

### Example 4

Synthesis of Special Monomers as Building units for Radical co-polymerization of Instant degradable Polystyrene:

1) Preparation and synthesis of specially designed allylic or vinylic monomers in polystyrene co-polymerization with the regular styrene monomer and other desired monomers to obtain a copolystyrene polymer with intrinsic latent-“instant-degradable chemical properties”:

PG—Y=specially designed protective group.

X=latent nucleophile with catalytic properties

Enabling polymer backbone degradation instantly-upon chemical command [like the dissolution of sugar in water]

A. PG=must be preferably aromatic but can be aliphatic

B. PG=must contribute the appropriate aromatic or aliphatic mechanical properties to the general properties of the polystyrene

C. Y=must contain specific covalent bond qualities in order to allow selective cleavage of the protective group upon command.

D. Y=must be a stable chemical bond during product formulation, handling, and use.

E. R′—X—Y—R=must be stable to radical degradation during styrene co-polymerization.

F. monomers and degradation products must be friendly to the environment and degradation products should be of economic interest.

### Example 5

Co-polymerication of monomers to obtain a latent nucleophilic nucleus in the polymer backbone:

A) a combination of styrene with the newly designed monomers, combined with a third monomer, which is known in the art to co-polymerize and yield ester bonds in polystyrene is mixed.

B) Appropriate co-polymerization conditions are developed in order to obtain a suitable co-polystyrene-ester polymer, with appropriate mechanical properties for product casting and/or other applications.

C) The resulting polymer contains:

1. overall mechanical properties similar to the regular polystyrene due to aromatic contributions of the styrene, the aromatic protecting group, and aromatic group in the third monomer which introduces an ester group in the polystyrene backbone.

2. the newly designed monomer contains “latent solubility properties”, which upon chemical reaction express these solubility qualities in the overall polymer backbone, thus enabling comfortable handling of polymeric rubbish.

3. the newly designed monomer incorporates a latent catalytic nucleophile, which upon specific chemical activation would start catalytic intramolecular hydrolysis of inserted ester bonds in the general co-polystyrene backbone.

4. monomers are chosen according to commercial and economic requirements regarding obtaining and purification of degradation products-which could be sold, for example as pepidomimetic reagents, or other fine chemicals.

Copolymerization at appropriate ratios of monomers to form an Instant-Degradable Co-Polyurethane

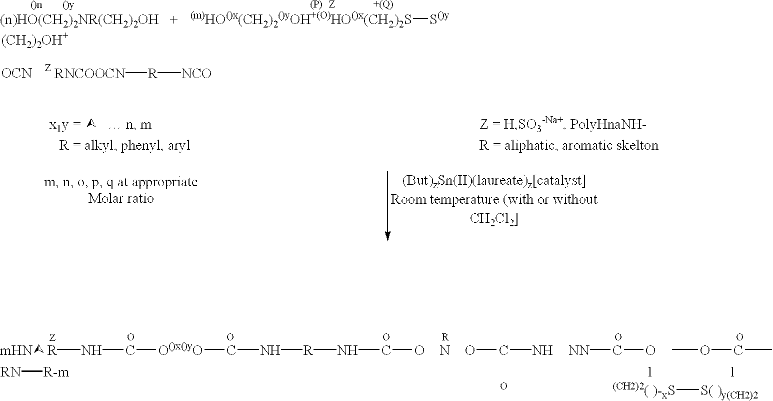

Schematic representation of the preparation of the disuphide plastic product

1. (h) monomer and (p) monomer aquireto the co-polyurethane product improved solubility, upon dissolution in reducing agent solution for instant degradation.—but not under normal aqueous conditions.

2. (m) monomer acquires flexibility properties to mechanical properties of the polymer product.

3. (p) monomer acquires hydrophobic and mechanical properties of the polymer when Z═H; when Z═SO₃ —Na⁺,

$$NH — {C}^{NH} —NH—$$

solubility qualities are introduced to the Carbon backbone; modifying these ratios between Z═H, and Z═SO₃⁻

$$NH — {C}^{+ NH} —NH—$$

enables to control the overall aqueous and solubility properties or the Instant-Degradable polymer—thus enabling an effective thiol-disulfide cleavage under appropriate conditions.

### Example 6

Five examples in each group of polymers (synthetic and degradation)

Five examples in each group of polymers (synthetic and degradation)

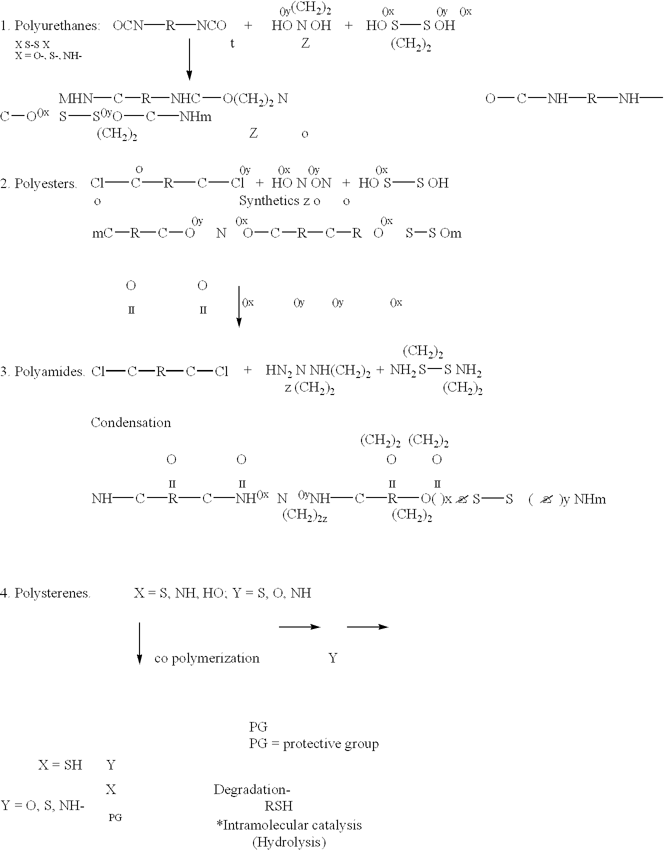

### Example 7

Preparation of Monomers designed as Precursors for Instant-Degradable Plastics, presented schematically:

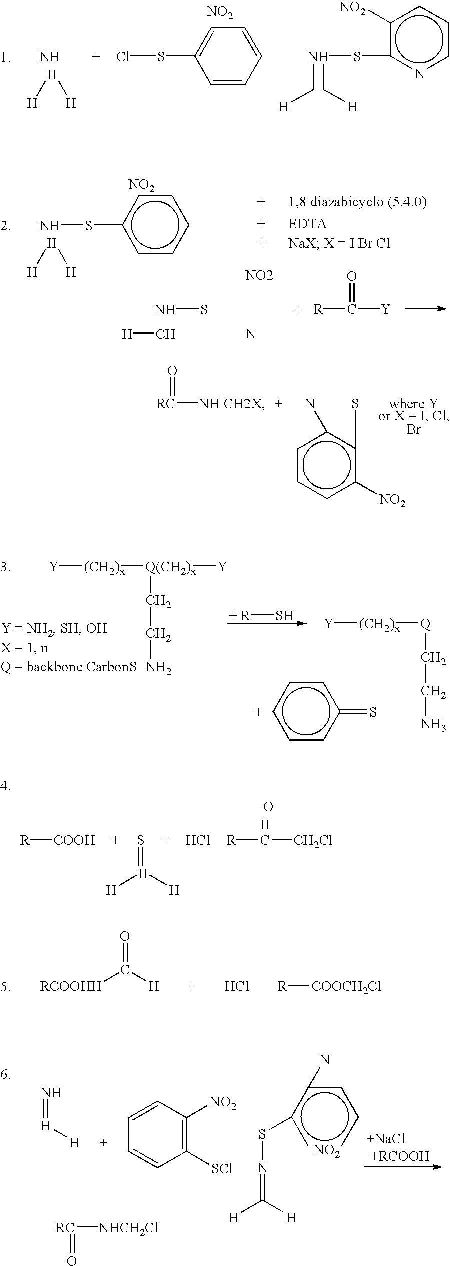

19. 4-guanidino butylamine+Glycerol as in 18 above.

20. -guanidinobutyric acid as in 18 above.

21. β-guanidinopropanoic acid as in 18 above.

22. Guanidinosuccinic acid as in 18 above.

23. Guanidinoacetic acid as in 18 above.

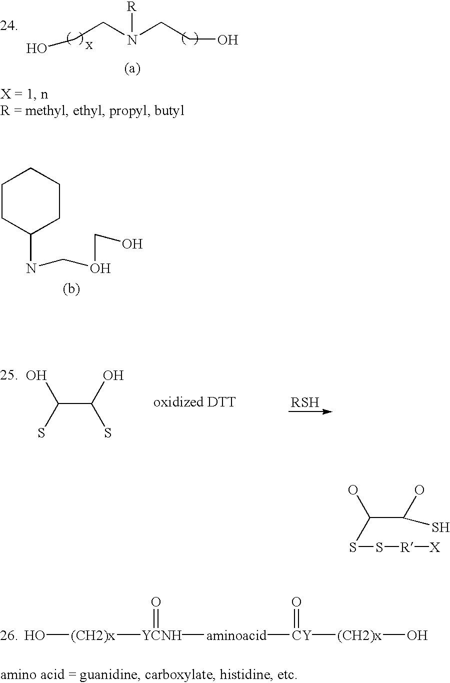

amino acid=guanidine, carboxylate, histidine, etc.

Although the present invention is described in connection with particular preferred embodiments and examples, it is to be understood that many modifications and variations can be made in the process and apparatus without departing from the scope to which the inventions disclose herein are entitled. Accordingly it will be understood that these embodiments are illustrative and that the scope of the invention is not limited to them. The present invention is to be considered as including all apparatus, systems and methods encompassed by the appending claims.

What is claimed is: A degradable plastic product comprising a hydrolytically degradable polymer and a modifier, wherein said modifier is compatible with said polymer and is non-volatile and non-fugitive and wherein said polymer comprises repeating monomer units selected from the group consisting of HO (CH₂)₂ S—S (CH₂)₂

1. derivatives.

2. The degradable plastic product according to claim 1, wherein said degradable polymer comprising structures including (—CH2—CH—)n, (CH2—CH2—)n,(—CF₂₋CF₂)n.

3. The degradable plastic product according to claim 1, wherein said degradable polymer comprises at least about 1% to 50% weight, percent repeating units derived from amino-sulfenyl groups, the oxygen-sulfenyl groups or the disulphide groups.

4. A degradable plastic product prepared from a composite comprising a blend of polymers selected from the group consisting of polyurethanes, polyesters, polyamides, polystyrenes, acetals, acrylics, cellulosics, fluoropolymers, nylons, polycarbonate, polyvinyl chloride, polypropylene, or polyethylene, a non-toxic modifier and a latent disulfide moiety.

5. The article according to claim 4, which has physical and mechanical properties of conventional plastic products which are difficult to degrade.
